(19) United States
(12) Patent Application Publication
(10) Pub. No.: US 2026/0012884 A1
(43) Pub. Date: Jan. 8, 2026

(54) METHOD AND SYSTEM FOR ESTABLISHING COORDINATION BETWEEN A PLURALITY OF ACCESS POINTS IN WIRELESS NETWORK

(71) Applicant: Samsung Electronics Co., Ltd., Suwon-si (KR)

(72) Inventors: Abhishek CHATURVEDI, Bangalore (IN); Karthik Srinivasa GOPALAN, Bangalore (KR); Manasi EKKUNDI, Bengaluru (IN)

(21) Appl. No.: 19/268,031

(22) Filed: Jul. 14, 2025

Related U.S. Application Data
(63) Continuation of application No. PCT/KR2025/009070, filed on Jun. 27, 2025.

(30) Foreign Application Priority Data
Jul. 2, 2024 (IN) 202441050577
May 28, 2025 (IN) 202441050577

(51) Int. Cl. H04W 52/02

(52) U.S. Cl. CPC H04W 52/0206

(57) ABSTRACT

A method for establishing coordination between a plurality of Access Points (APs) in a wireless network is provided. The method includes: initiating a Multi-AP Coordination for AP Power Saving (MAPC for AP PS) scheme, for the plurality of APs, based on one or more trigger parameters associated with a primary AP; receiving one or more broadcast frames from each of a plurality of secondary APs among the plurality of APs, the one or more broadcast frames comprise capability information corresponding to the secondary AP; identifying one or more neighbor APs from the plurality of secondary APs based on the received capability information; and performing one or more negotiation operations with the one or more identified neighbor APs to establish coordination between the primary AP and the one or more identified neighbor APs for coordinated data communication in the MAPC for AP PS scheme.

### CROSS-REFERENCE TO RELATED APPLICATIONS

This application is a continuation of International Application No. PCT/KR2025/009070 designating the United States, filed on Jun. 27, 2025, in the Korean Intellectual Property Receiving Office and claiming priority to Indian Provisional Patent Application No. 202441050577, filed on Jul. 2, 2024, and Indian Complete patent application No. 202441050577, filed on May 28, 2025, in the Indian Patent Office, the disclosures of each of which are incorporated by reference herein in their entireties.

### TECHNICAL FIELD

The disclosure relates to the field of wireless communication systems, and for example, to a method and a system for establishing coordination between a plurality of Access Points (APs) in a wireless network.

### BACKGROUND

The information disclosed in this background section is to aid in understanding of the general background of the disclosure and should not be taken as an acknowledgement or any form of suggestion that this information forms the prior art already known to one skilled in the art.

In the context of wireless communication systems, Institute of Electrical and Electronics Engineers (IEEE) 802.11 Ultra High Reliability (UHR) is a wireless communication standard designed to enhance the reliability and performance of the 8th generation of Wireless-Fidelity (Wi-Fi) networks. The IEEE 802.11 UHR aims to support critical applications that require consistent and stable connectivity. For instance, consider a typical home environment where various IEEE 802.11-enabled devices coexist, as illustrated in FIG. 1, including appliances like TVs, air conditioners, microwaves, refrigerators, and smart light bulbs. Family members also use multiple devices such as smartphones, tablets, laptops, wearables, Augmented Reality (AR)/Virtual Reality (VR)/Extended Reality (XR) devices, and power-data-hungry gaming setups. Additionally, the home environment may feature Internet of Things (IoT) devices with smart sensors connecting over 802.11 networks. In denser ecosystems/environments, like apartment complexes, offices, malls, and airports, many users share the same network. Industrial settings also require reliable 802.11 connectivity for various functions, instruments, and requirements. The diverse ecosystem includes devices with different data performance and power needs.

For example, IoT sensors typically require low latency and power, while laptops and TVs need high throughput for tasks like streaming and gaming. XR devices demand high throughput, reliability, low latency, and mobility, which leads to increased power consumption. To accommodate these varying needs, the current 802.11 standard includes power-saving schemes for both non Access Point (AP)/Station (STA) clients and APs. However, several problems are encountered in the existing/proposed (e.g., in Wi-Fi8 contributions) AP power-saving schemes, which are mentioned below.

For example, certain existing methods utilize capability reduction functionality, to conserve power during frame exchanges, where the AP may lower its operating bandwidth, reduce a Number of Spatial Streams (NSSs), or change a Modulation and Coding Scheme (MCS). These adjustments are communicated to all connected client devices, leading to long-term changes that can decrease throughput and increase latency. For another instance, certain existing method utilizes link disablement functionality, where an AP Multi-Link Device (MLD) can disable one or more links while keeping at least one link active. This forces clients to either stop using the disabled link or switch to another Basic Service Set (BSS). This method can result in no throughput, no service, and lengthy transition times.

For example, certain existing methods utilize scheduled AP Power Saving (PS) functionality, where the AP can signal an intention to enter a low-power state (doze state) by setting a bit in a beacon frame. This occurs outside the agreed target wake time service period (negotiated) or a specific restricted access window. While this method has a moderate impact, no throughput and no service occur during one or more off periods (outside of the service periods). For example, certain existing methods utilize dynamic AP PS functionality, this method involves switching between Low and High Capability States (LCS/HCS) based on an activation of dynamic Spatial Multiplexing Power Save (SMPS) or enhanced Multi-Link Single Radio (eMLSR) concepts. These short-term changes affect all clients on that link, such as sending control frames to enable or disable higher bandwidth and spatial stream modes.

In the context of wireless communication systems, various types of APs exist. Today, most digital devices, including both clients and APs, require operation at high bandwidths to deliver fast services. This demand contributes to a larger carbon footprint and increased power consumption for both battery-operated and wall-mounted/powered devices. The APs consume a significant amount of energy, typically in the tens of watts, leading to high energy costs and maintenance challenges. This issue becomes even more relevant for Multi-Link Devices (MLDs) introduced in the Wi-Fi 7 IEEE 802.11 standards. Current Wi-Fi specifications include various protocols and options for the PS in the APs. The 802.11 UHR standards emphasize improving energy efficiency for Wi-Fi 8 APs, with several proposals for power-saving measures. Examples of AP types and their power-saving strategies may include battery-powered APs such as soft APs, mobile hotspots, and mobile APs. Socket-powered APs, like home APs, can save power during early morning hours. Enterprise and industry APs can reduce power consumption during non-working hours, while stadium and mall APs can save energy outside of operating hours. Maintaining an ON state for the APs as much as possible remains crucial for enabling client devices to scan, discover, associate, and communicate effectively. This necessity creates a balance between power-saving strategies and the performance requirements of the PS for APs.

In addition, various multi-AP coordination schemes are being explored to enhance the Wi-Fi 8 standards. The multi-AP coordination concept allows the AP to discover nearby APs, exchange information, and negotiate, forming a group of coordinated APs. This coordination aims to reduce co-channel interference and optimize channel usage while meeting UHR Key Performance Indicators (KPIs). The following coordination schemes are currently under consideration, for example, Coordinated Access Points (C-AP), Coordinated Time Division Multiple Access (C-TDMA), Coordinated (Restricted) Target Wakeup Time (C-(R)TWT), Coordinated Beam Forming (C-BF), Coordinated Spatial Reuse (C-SR), and Coordinated Joint Transmissions (C-JT) for both coherent and non-coherent transmissions. Moreover, a specific scenario involves dedicated coordination between a serving AP and potential target APs within the same mobility domain, particularly during roaming. The goal is to achieve near-lossless data roaming between two non-collocated APs with minimal latency. The most widely accepted architecture for Wi-Fi 8 standards includes enhanced context transfer through a common control entity between APs or over a Distribution System (DS). This approach reduces signalling steps, incorporates pre-authentication and pre-configuration, and allows for advanced signalling with multiple potential roaming candidate APs to facilitate faster client association changes during roaming scenarios. However, several problems are encountered in the existing multi-AP coordination schemes, which are mentioned below.

Most existing multi-AP coordination schemes focus on protecting a Transmission Opportunity (TXOP) acquired through Clear Channel Assessment (CCA) or Enhanced Distributed Channel Access (EDCA) procedures for the AP. Techniques such as the C-TDMA and the C-(R)TWT aim to safeguard the TXOP, while methods like the C-SR, the C-BF, and the C-JT seek to minimize and/or reduce interference and enhance transmission reliability through coordination with neighboring APs. These methods/schemes primarily protect a “wake-up” or “active” periods of the AP as part of its power-saving strategy.

However, there is currently no protection or coordination for the periods when the AP is in doze, inactive, or LCS. These sleep, doze, or LCS are critical for achieving the expected power savings essentially minimizing/reducing the power consumption of any AP device. Unfortunately, these states can be easily disrupted by various external factors, for example, including, (a) a trigger or control frame received in low-power listen-only mode, such as a Wake-Up Radio (WUR) frame, which may cause the AP to transition to a fully awake state; (b) a Station (STA) necessitates the AP to shift from LCS to HCS to meet Quality of Service (QOS) requirements, despite the presence of another neighboring AP that could provide equivalent HCS support; (c) an STA with high-priority, time-sensitive traffic preempts the ongoing data transmission of the AP, leading to a suspension and later resumption of that transmission. This may result in the AP remaining awake longer than necessary, even though the high-priority data could have been handled by another nearby AP simultaneously; (d) Other dynamic factors are related to channel conditions and data transmission environments; and (e) These interruptions adversely affect STA performance, resulting in service loss, increased signalling overhead, inefficient use of radio resources, and higher STA power consumption.

Protecting these low-power consumption states is equally important for achieving desired KPIs related to power savings. So, a framework is needed to establish coordinated power-saving schemes among neighboring APs to minimize interruption events and optimize simultaneous channel usage effectively. Thus, it is desired to address the above-mentioned disadvantages or other shortcomings or at least provide a useful alternative for establishing coordination between a plurality of APs in the wireless network.

### SUMMARY

One aspect of the present disclosure provides a method for establishing coordination between a plurality of Access Points (APs) in a wireless network is disclosed herein. The method includes: initiating, at a primary AP, a Multi-AP Coordination for AP Power Saving (MAPC for AP PS) scheme, for the plurality of APs, based on one or more trigger parameters associated with the primary AP; receiving, by the primary AP, one or more broadcast frames from each of a plurality of secondary APs among the plurality of APs, wherein the one or more broadcast frames comprise capability information corresponding to the secondary AP; identifying, by the primary AP, one or more neighbor APs from the plurality of secondary APs based on the received capability information; and performing, by the primary AP, one or more negotiation operations with the one or more identified neighbor APs to establish coordination between the primary AP and the one or more identified neighbor APs for coordinated data communication in the MAPC for AP PS scheme.

In an embodiment, performing the one or more negotiation operations comprises: receiving, by the primary AP, a power profile from each of the one or more identified neighbor Aps, wherein the power profile is obtained from an optional bitmap for Power Saving (PS) profile included in the received capability information, or wherein the power profile is received through a dedicated signalling during the one or more negotiation operations; analyzing, by the primary AP, the received power profile using a negotiation function implemented either at the primary AP or a Backend Distribution system (DS) of the AP; generating, by the primary AP, an optimal Negotiated PS Profile (NPP), for each of the one or more identified neighbor APs including the primary AP, based on one or more of a result of analysis and meeting one or more specified criteria for NPP policies; and transmitting, by the primary AP, the generated optimal NPP to the one or more corresponding identified neighbor APs.

In an embodiment, the optimal NPP comprises one or more of an MAPC group identity, a number of APs, an identity of AP, a PS start offset, a PS type, a PS mode, a PS duration, a PS mode bandwidth, a PS mode Number of Spatial Streams (NSS), a PS mode Modulation and Coding Scheme (MCS), a PS mode link, and an extension bit.

In an embodiment, the MAPC group identity indicates a unique group identifier for the plurality of APs coordinating in the MAPC for AP PS scheme. The number of APs indicates a total count of the plurality of APs in the MAPC for AP PS scheme. The PS start offset indicates an initial padding delay required for a configuration and application of the PS profile. The PS type indicates a 2-bit field that specifies the PS type, including one or more type options, the PS mode indicates a 2-bit field that specifies the PS mode, including one or more states. The PS duration indicates a total duration for which the PS profile is to be applied. The PS mode bandwidth indicates a 3-bit identifier representing a total Overlapping Basic Service Set (OBSS) bandwidth supported by the AP for a current PS profile. The PS mode NSS indicates a 2-bit identifier representing a total number of spatial streams supported by the AP in the current PS profile. The PS mode MCS indicates a 5-bit identifier representing a maximum modulation and coding scheme supported by the AP in the current PS profile. The PS mode link indicates a 2-bit identifier representing one or more links supported by the AP in the current PS profile. The extension bit indicates a 1-bit identifier representing a type of the PS scheme that is executed next in sequential order for the same AP.

In an embodiment, the method comprises determining whether a value of the extension bit is set to one or zero. The method comprises initiating a subsequent PS profile immediately upon the completion of the current PS profile for the same AP in response to determining that the value of the extension bit is set to one. The method comprises terminating the current PS profile, followed by the PS profile for a next identity of AP in the NPP in response to determining that the value of the extension bit is set to zero.

In an embodiment, the one or more specified criteria for NPP policies comprises: determining whether a unique MAPC group identity is assigned for use by plurality of APs; determining whether an equal opportunity is provided for power conservation to each of the plurality of APs; determining whether at least one Overlapping Basic Service Set (OBSS) AP is present in a High Capability State (HCS) power state based on at least one traffic pattern demand; determining whether the at least OBSS AP is present in a Low Capability State (LCS) power state based on the at least one traffic pattern demand; determining whether an overlapping region with the at least one OBSS AP in awake state exists at any time instance to avoid one or more coverage holes; and/or determining whether one or more PS profile patterns are optimized and allocating the NPP back to the plurality of APs.

In an embodiment, the one or more trigger parameters comprise traffic profile data, power-saving requirements and any additional triggers applicable to one or more of an enterprise environment and a non-enterprise environment.

In an embodiment, the capability information comprises one or more of an identity of AP, an MAPC for PS support capability, an MAPC group identity, a bitmap for other MAPC schemes supported, and a PS profile of the AP.

In an embodiment, the identity of AP identifies each AP uniquely during an MAPC for PS configuration and signalling with other APs. The MAPC for PS support capability indicates support for the MAPC for AP PS scheme. The MAPC group identity indicates a valid Group ID when the AP is part of a previously configured MAPC for AP PS group. The bitmap for other MAPC schemes support indicates a support for one or more other type of MAPC coordination schemes. The one or more other type of MAPC coordination schemes comprise one or more of a Coordinated Time Division Multiple Access (Co-TDMA), a Coordinated Restricted Target Wakeup Time (Co-RTWT), a Coordinated Spatial Reuse (Co-SR), a Coordinated Beam Forming (Co-BF), a Coordinated Joint Transmissions (C-JT), and a Coordinated Access Points (C-AP). The PS profile indicates information related to AP PS requirements and comprises one or more additional supplementary elements. The one or more additional supplementary elements comprise one or more of a traffic pattern, a sleep pattern, an awake pattern, a Quality of Service (QOS) requirement, AP's High Capability State (HCS) or Low Capability State (LCS) support and corresponding application pattern. The capability information is broadcasted by utilizing a management frame using at least one of a beacon frame or probe request/response frames.

In an embodiment, the PS profile of the AP is configured by determining one or more evaluation parameters associated with the AP by utilizing at least one of data analytics functions, and configuring the PS profile based on the one or more determined evaluation parameters. The one or more evaluation parameters are determined based on one or more of an analysis of user density and traffic patterns served by the AP at various time periods, an identification of one or more of a static characteristic and a dynamic characteristic of one or more data patterns, an analysis of link-level data usage for Multi-Link Devices (MLD AP), a Quality of Service (QOS) requirement associated with the one or more data patterns, a load balancing requirement, an analysis of data generation and corresponding operational time patterns for different types of standard wireless communication enabled devices, and an analysis of power-saving requirements based on one or more AP device type classifications. The PS profile comprises one or more of a low-power state and a high-power state and corresponding validity duration.

In an embodiment, the method comprises determining, by the primary AP, whether the one or more negotiation operations has completed within a Coordination Window (CW) timer, wherein the primary AP initiates the CW timer at the time of initiation of the MAPC for AP PS scheme; in response to determining that the one or more negotiation operations has completed within the CW timer, initiating, by the primary AP, a Guard Window (GW) timer; and in response to initiating the GW timer, establishing the coordination between the primary AP and the one or more identified neighbor APs for the coordinated data communication aiming the MAPC for AP PS scheme. Each of the primary AP and the one or more identified neighbor APs perform one or more required specified operations within a respective Basic Service Set (BSS). Each of the primary AP and the one or more participating APs apply individual NPP profile within respective BSS. Each of the primary AP and the one or more participating APs, in active state, apply any other configured MAPC schemes within respective BSS during coordinated transmissions. Each of the primary AP and the one or more participating APs updates the valid MAPC group identifier in corresponding MAPC group related broadcast information in the corresponding capability element. Each of the primary AP and the one or more participating APs ensures to inform associated client devices/stations (STAs) about the AP's configured PS profiles or states and corresponding availability information. Each of the primary AP and the one or more identified neighbor APs initiates coordinated transmissions within respective BSS. Each of the primary AP and the one or more identified neighbor APs handles any disrupting client or station (STA) to protect and maintain a negotiated power profile for optimal power saving.

In an embodiment, the method comprises determining, by the primary AP, whether the coordinated transmissions have started within the GW timer. The method comprises, after the expiration of the GW timer, handling, by the primary AP, one or more trigger conditions, that are cither periodic, aperiodic or event based, that lead to a re-negotiation procedure associated with the plurality of secondary APs.

In an embodiment, the CW is a specified time period during which the primary AP waits for one or more responses from the one or more identified neighbor APs to participate in the one or more negotiation operations to establish coordination between the primary AP and the one or more identified neighbor APs. The GW is a specified time period during which coordinated APs implement one or more agreements and operate via coordinated state and transmissions within the wireless network, to reduce one or more external APs from disrupting the coordination by trying to participate in the ongoing MAPC for AP PS scheme until the GW has expired.

In an embodiment, the handling of any disrupting STA comprises one or more operations. The one or more operations comprise: determining, by a first AP among all the participating APs in MAPC for AP PS scheme, whether a service or state interruption occurs due to one or more STAs associated with a first AP or whether a service requirement of the one or more STAs associated with the first AP meets a specified service criteria; and reallocating, by the first AP, the one or more STAs to a second AP among the one or more identified neighbor APs, which are all aware of neighbor AP's current PS profile and state of operations via coordination under the MAPC for AP PS scheme, to provide one or more network services, in response to determining that the service interruption occurs at one or more STAs associated with the first AP and the service requirement of the one or more STAs associated with the first AP does not meet the specified service criteria.

In an embodiment, the method comprises performing, by the primary AP, at least one of negotiating and distributing user density and traffic among the one or more identified neighbor APs based on a type of traffic and a service requirement.

One aspect of the present disclosure provides a primary access point (AP) for establishing coordination between a plurality of Access Points (APs) in a wireless network. The primary AP comprises at least one processor including processing circuitry. The primary AP comprises memory storing instructions that, when executed by the at least one processor individually or collectively, cause the primary AP to initiate a Multi-AP Coordination for AP Power Saving (MAPC for AP PS) scheme, for the plurality of APs, based on one or more trigger parameters associated with a primary AP. The instructions, when executed by the at least one processor individually or collectively, cause the primary AP to receive one or more broadcast frames from each of a plurality of secondary APs among the plurality of APs, wherein the one or more broadcast frames comprise capability information corresponding to the secondary AP. The instructions, when executed by the at least one processor individually or collectively, cause the primary AP to identify one or more neighbor APs from the plurality of secondary APs based on the received capability information. The instructions, when executed by the at least one processor individually or collectively, cause the primary AP to perform one or more negotiation operations with the one or more identified neighbor APs to establish coordination between the primary AP and the one or more identified neighbor APs for coordinated data communication in the MAPC for AP PS scheme.

In an embodiment, to perform the one or more negotiation operations, the instructions, when executed by the at least one processor individually or collectively, cause the primary AP to: receive a power profile from each of the one or more identified neighbor APs, wherein the power profile is obtained from an optional bitmap for Power Saving (PS) profile included in the received capability information, or wherein the power profile is received through a dedicated signalling during the one or more negotiation operations; analyze the received power profile using a negotiation function implemented either at the primary AP or a Backend Distribution system (DS) of the AP; generate an optimal Negotiated PS Profile (NPP), for each of the one or more identified neighbor APs including the primary AP, based on at least one of a result of analysis and meeting one or more specified criteria for NPP policies; and transmit the generated optimal NPP to the one or more corresponding identified neighbor APs.

In an embodiment, the optimal NPP comprises one or more of an MAPC group identity, a number of APs, an identity of AP, a PS start offset, a PS type, a PS mode, a PS duration, a PS mode bandwidth, a PS mode Number of Spatial Streams (NSS), a PS mode Modulation and Coding Scheme (MCS), a PS mode link, and an extension bit.

In an embodiment, the MAPC group identity indicates a unique group identifier for the plurality of APs coordinating in the MAPC for AP PS scheme. The number of APs indicates a total count of the plurality of APs in the MAPC for AP PS scheme. The PS start offset indicates an initial padding delay required for a configuration and application of the PS profile. The PS type indicates a 2-bit field that specifies the PS type, including one or more type options, the PS mode indicates a 2-bit field that specifies the PS mode, including one or more states. The PS duration indicates a total duration for which the PS profile is to be applied. The PS mode bandwidth indicates a 3-bit identifier representing a total Overlapping Basic Service Set (OBSS) bandwidth supported by the AP for a current PS profile. The PS mode NSS indicates a 2-bit identifier representing a total number of spatial streams supported by the AP in the current PS profile. The PS mode MCS indicates a 5-bit identifier representing a maximum modulation and coding scheme supported by the AP in the current PS profile. The PS mode link indicates a 2-bit identifier representing one or more links supported by the AP in the current PS profile. The extension bit indicates a 1-bit identifier representing a type of the PS scheme that is executed next in sequential order for the same AP.

In an embodiment, the instructions, when executed by the at least one processor individually or collectively, cause the primary AP to determine whether a value of the extension bit is set to one or zero. The instructions, when executed by the at least one processor individually or collectively, cause the primary AP to initiate a subsequent PS profile immediately upon the completion of the current PS profile for the same AP in response to determining that the value of the extension bit is set to one. The instructions, when executed by the at least one processor individually or collectively, cause the primary AP to terminate the current PS profile, followed by the PS profile for a next identity of AP in the NPP in response to determining that the value of the extension bit is set to zero.

In an embodiment, the one or more specified criteria for NPP policies comprises: determining whether a unique MAPC group identity is assigned for use by plurality of APs; determining whether an equal opportunity is provided for power conservation to each of the plurality of APs; determining whether at least one Overlapping Basic Service Set (OBSS) AP is present in a High Capability State (HCS) power state based on at least one traffic pattern demand; determining whether the at least OBSS AP is present in a Low Capability State (LCS) power state based on the at least one traffic pattern demand; determining whether an overlapping region with the at least one OBSS AP in awake state exists at any time instance to avoid one or more coverage holes; and/or determining whether one or more PS profile patterns are optimized and allocating the NPP back to the plurality of APs.

In an embodiment, the one or more trigger parameters comprise traffic profile data, power-saving requirements and any additional triggers applicable to one or more of an enterprise environment and a non-enterprise environment.

In an embodiment, the capability information comprises one or more of an identity of AP, an MAPC for PS support capability, an MAPC group identity, a bitmap for other MAPC schemes supported, and a PS profile of the AP.

In an embodiment, the identity of AP identifies each AP uniquely during an MAPC for PS configuration and signalling with other APs. The MAPC for PS support capability indicates support for the MAPC for AP PS scheme. The MAPC group identity indicates a valid Group ID when the AP is part of a previously configured MAPC for AP PS group. The bitmap for other MAPC schemes support indicates a support for one or more other type of MAPC coordination schemes. The one or more other type of MAPC coordination schemes comprise one or more of a Coordinated Time Division Multiple Access (Co-TDMA), a Coordinated Restricted Target Wakeup Time (Co-RTWT), a Coordinated Spatial Reuse (Co-SR), a Coordinated Beam Forming (Co-BF), a Coordinated Joint Transmissions (C-JT), and a Coordinated Access Points (C-AP). The PS profile indicates information related to AP PS requirements and comprises one or more additional supplementary elements. The one or more additional supplementary elements comprise one or more of a traffic pattern, a sleep pattern, an awake pattern, a Quality of Service (QOS) requirement, AP's High Capability State (HCS) or Low Capability State (LCS) support and corresponding application pattern. The capability information is broadcasted by utilizing a management frame using at least one of a beacon frame or probe request/response frames.

In an embodiment, the PS profile of the AP is configured by determining one or more evaluation parameters associated with the primary AP by utilizing at least one of data analytics functions, and configuring the PS profile based on the one or more determined evaluation parameters. The one or more evaluation parameters are determined based on one or more of an analysis of user density and traffic patterns served by the primary AP at various time periods, an identification of one or more of a static characteristic and a dynamic characteristic of one or more data patterns, an analysis of link-level data usage for Multi-Link Devices (MLD AP), a Quality of Service (QOS) requirement associated with the one or more data patterns, a load balancing requirement, an analysis of data generation and corresponding operational time patterns for different types of standard wireless communication enabled devices, and an analysis of power-saving requirements based on one or more AP device type classifications. The PS profile comprises one or more of a low-power state and a high-power state and corresponding validity duration.

In an embodiment, the instructions, when executed by the at least one processor individually or collectively, cause the primary AP to determine whether the one or more negotiation operations has completed within a Coordination Window (CW) timer, wherein the primary AP initiates the CW timer at the time of initiation of the MAPC for AP PS scheme; in response to determining that the one or more negotiation operations has completed within the CW timer, initiate a Guard Window (GW) timer; and in response to initiating the GW timer, establish the coordination between the primary AP and the one or more identified neighbor APs for the coordinated data communication aiming the MAPC for AP PS scheme. Each of the primary AP and the one or more identified neighbor APs perform one or more required specified operations within a respective Basic Service Set (BSS). Each of the primary AP and the one or more participating APs apply individual NPP profile within respective BSS. Each of the primary AP and the one or more participating APs, in active state, apply any other configured MAPC schemes within respective BSS during coordinated transmissions. Each of the primary AP and the one or more participating APs updates the valid MAPC group identifier in corresponding MAPC group related broadcast information in the corresponding capability element. Each of the primary AP and the one or more participating APs ensures to inform associated client devices/stations (STAs) about the AP's configured PS profiles or states and corresponding availability information. Each of the primary AP and the one or more identified neighbor APs initiates coordinated transmissions within respective BSS. Each of the primary AP and the one or more identified neighbor APs handles any disrupting client or station (STA) to protect and maintain a negotiated power profile for optimal power saving.

In an embodiment, the instructions, when executed by the at least one processor individually or collectively, cause the primary AP to determine whether the coordinated transmissions have started within the GW timer. after the expiration of the GW timer, handle one or more trigger conditions, that are either periodic, aperiodic or event based, that lead to a re-negotiation procedure associated with the plurality of secondary APs.

In an embodiment, the CW is a specified time period during which the primary AP waits for one or more responses from the one or more identified neighbor APs to participate in the one or more negotiation operations to establish coordination between the primary AP and the one or more identified neighbor APs. The GW is a specified time period during which coordinated APs implement one or more agreements and operate via coordinated state and transmissions within the wireless network, to reduce one or more external APs from disrupting the coordination by trying to participate in the ongoing MAPC for AP PS scheme until the GW has expired.

In an embodiment, the handling of any disrupting STA comprises one or more operations. The one or more operations comprise: determining, by a first AP among all the participating APs in MAPC for AP PS scheme, whether a service or state interruption occurs due to one or more STAs associated with a first AP or whether a service requirement of the one or more STAs associated with the first AP meets a specified service criteria; and reallocating, by the first AP, the one or more STAs to a second AP among the one or more identified neighbor APs, which are all aware of neighbor AP's current PS profile and state of operations via coordination under the MAPC for AP PS scheme, to provide one or more network services, in response to determining that the service interruption occurs at one or more STAs associated with the first AP and the service requirement of the one or more STAs associated with the first AP does not meet the specified service criteria.

In an embodiment, the instructions, when executed by the at least one processor individually or collectively, cause the primary AP to perform at least one of negotiating and distributing user density and traffic among the one or more identified neighbor APs based on a type of traffic and a service requirement.

One aspect of the present disclosure provides a non-transitory computer-readable storage medium. The methods disclosed herein can be performed by one or more computer programs stored on the non-transitory computer-readable storage medium.

In an embodiment, a non-transitory computer-readable storage medium storing one or more computer programs is provided, The one or more computer programs, when executed by at least one processor individually or collectively, cause the primary AP to perform a method for establishing coordination between a plurality of Access Points (APs) in a wireless network. The method includes: initiating, at a primary AP, a Multi-AP Coordination for AP Power Saving (MAPC for AP PS) scheme, for the plurality of APs, based on one or more trigger parameters associated with the primary AP; receiving, by the primary AP, one or more broadcast frames from each of a plurality of secondary APs among the plurality of APs, wherein the one or more broadcast frames comprise capability information corresponding to the secondary AP; identifying, by the primary AP, one or more neighbor APs from the plurality of secondary APs based on the received capability information; and performing, by the primary AP, one or more negotiation operations with the one or more identified neighbor APs to establish coordination between the primary AP and the one or more identified neighbor APs for coordinated data communication in the MAPC for AP PS scheme.

To further clarify the advantages and features of the present disclosure, a more particular description will be rendered by reference to various example embodiments thereof, which are illustrated in the appended drawings. It is appreciated that these drawings depict example embodiments and are therefore not to be considered limiting of its scope. The disclosure will be described and explained with additional specificity and detail in the accompanying drawings.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings, an in which:

FIG. 1 is a diagram illustrating a digital device ecosystem, according to related art;

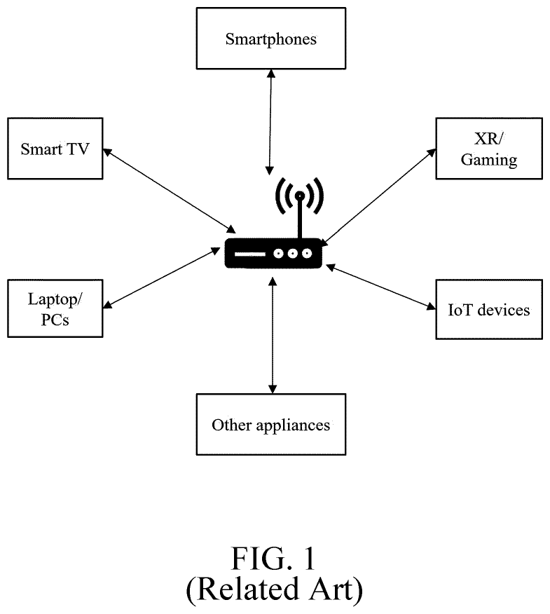

FIG. 2 is a block diagram illustrating an example configuration of an Access Point (AP) in a wireless network, according to various embodiments;

FIG. 3 is a diagram illustrating a plurality of phases associated with the AP to establish the coordination between the plurality of APs, according to various embodiments;

FIG. 4 is a signal flow diagram illustrating an example method for establishing Multi-AP (M-AP) coordination for AP Power Saving (PS) in Ultra High Reliability (UHR), according to various embodiments;

FIG. 5A is a diagram illustrating an example structure of a minimal set of information element to be broadcasted in beacon or probe response frames associated with the AP, according to various embodiments;

FIG. 5B is a diagram illustrating an example scenario where the AP configures its PS profile based on its power saving requirements, according to various embodiments;

FIG. 6 is a diagram illustrating an example Negotiated PS Profile (NPP) frame structure associated with the APs participating in the MAPC for AP PS scheme, according to various embodiments;

FIG. 7 is a diagram illustrating an example implementation of a negotiation process using the PS profile, according to various embodiments;

FIG. 8 is a diagram illustrating example power consumption over time in a use-case of an implementation of a Negotiated Power-saving Profile (NPP) in a residential scenario, according to various embodiments;

FIG. 9 is a diagram illustrating an example use-case scenario where a first AP allocates a disrupting station to a second AP, according to various embodiments; and

FIG. 10 is a flowchart illustrating an example method for establishing the coordination between the plurality of APs in the wireless network, according to various embodiments.

Further, skilled artisans will appreciate that elements in the drawings are illustrated for simplicity and may not have necessarily been drawn to scale. For example, the flowcharts illustrate a method in terms of steps involved to help to improve understanding of aspects of the present disclosure. Furthermore, in terms of the construction of the device, one or more components of the device may have been represented in the drawings by conventional symbols, and the drawings may show those specific details that are pertinent to understanding the various example embodiments so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to various example embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with the disclosure being included in at least one embodiment. Thus, appearances of the phrase “in an embodiment”, “in one embodiment”, “in another embodiment”, and similar language throughout this disclosure may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. The phrase “one or more of,” when used with a list of items, means that different combinations of one or more of the listed items may be used, and only one item in the list may be needed. For example, “one or more of: A, B, of C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The various example embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the example embodiments herein. The various example embodiments described herein are not necessarily mutually exclusive, as various embodiments can be combined with one or more other embodiments to form new embodiments. The term “or” as used herein, refers to a non-exclusive or unless otherwise indicated. The examples used herein are intended merely to facilitate an understanding of ways in which the example embodiments herein can be practiced and to further enable those skilled in the art to practice the example embodiments herein. Accordingly, the examples should not be construed as limiting the scope of the example embodiments herein.

Various example embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. The blocks of the example embodiments may be physically combined into more complex blocks without departing from the scope of the disclosure.

The accompanying drawings are used to help easily understand various technical features and it should be understood that the example embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

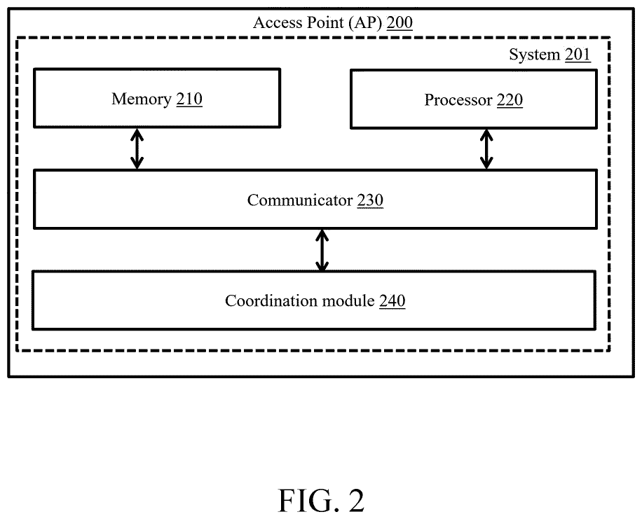

Referring now to the drawings, and more particularly to FIGS. 2 to 10, where similar reference characters denote corresponding features consistently throughout the figures, there are shown various example embodiments.

FIG. 2 is a block diagram illustrating an example configuration of an Access Point (AP) 200 in a wireless network, according to an embodiment as disclosed herein. Examples of the AP 200 may include, but are not limited to, home Wi-Fi routers, public Wi-Fi hotspots, enterprise APs, etc.

In various example embodiments, the AP comprises a system. The system 201 may include a memory 210, a processor (e.g., including processing circuitry) 220, a communicator (e.g., including communication circuitry) 230, and a coordination module (e.g., including various circuitry and/or executable program instructions) 240. In various embodiments, the system 201 may be implemented on one or multiple electronic devices (not shown in FIG. 2). The AP 200 may include at least one processor including processing circuitry. The at least one processor may include the combination of one or more processors such as the processor 220, the processing circuitry in the communicator 230, the processing circuitry in the coordination module 240, a CPU, GPU, MPU, an application processor (AP), and a communication processor (CP).

In various example embodiments, the memory 210 stores instructions to be executed by the processor 220 for establishing the coordination between the plurality of APs in the wireless network, as discussed throughout the disclosure. The memory 210 stores instructions that, when executed by the at least one processor 220 individually or collectively, cause the AP 200 to perform the methods and/or the operations described herein. The memory 210 may include non-volatile storage elements. Examples of such non-volatile storage elements may include magnetic hard discs, optical discs, floppy discs, flash memories, or forms of Electrically Programmable Memories (EPROM) or Electrically Erasable and Programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted that the memory 210 is non-movable. In various examples, the memory 210 can be configured to store larger amounts of information than the memory. In certain examples, a non-transitory storage medium may store data that can, over time, change (e.g., in Random Access Memory (RAM) or cache). The memory 210 can be an internal storage unit, or it can be an external storage unit of the AP 200, a cloud storage, or any other type of external storage.

In various example embodiments, the processor 220 may include various processing circuitry and communicates with the memory 210, the communicator 230, and the coordination module 240. The processor 220 is configured to execute instructions stored in the memory 210 and to perform various processes for establishing the coordination between the plurality of APs in the wireless network, as discussed throughout the disclosure. The communicator 230 can be controlled by the processor 220. The coordination module 240 can be controlled by the processor 220. The processor 220 may include one or a plurality of processors, maybe a general-purpose processor, such as a Central Processing Unit (CPU), an Application Processor (AP), or the like, a graphics-only processing unit such as a Graphics Processing Unit (GPU), a Visual Processing Unit (VPU), and/or an Artificial Intelligence (AI) dedicated processor such as a Neural Processing Unit (NPU). Thus, the processor 220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various example embodiments, the communicator 230 may include various communication circuitry and is configured for communicating internally between internal hardware components and with external devices (e.g., server) via one or more networks (e.g., radio technology). The communicator 230 may include an electronic circuit specific to a standard that enables wired or wireless communication.

In various example embodiments, the system 201 may include a display module (not shown in FIG. 2). The display module can accept user inputs and is made of a Liquid Crystal Display (LCD), a Light Emitting Diode (LED), an Organic Light Emitting Diode (OLED), or another type of display. The user inputs may include but are not limited to, touch, swipe, drag, gesture, and so on.

In various example embodiments, the coordination module 240 may be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The coordination module 240 may perform various operations for establishing the coordination between the plurality of APs in the wireless network, which are given below. As with the processor 220 above, the coordination module 240 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

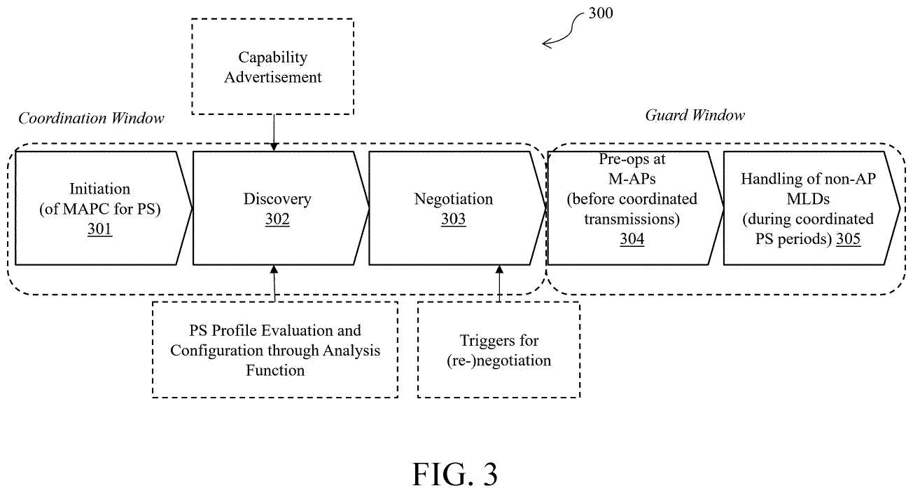

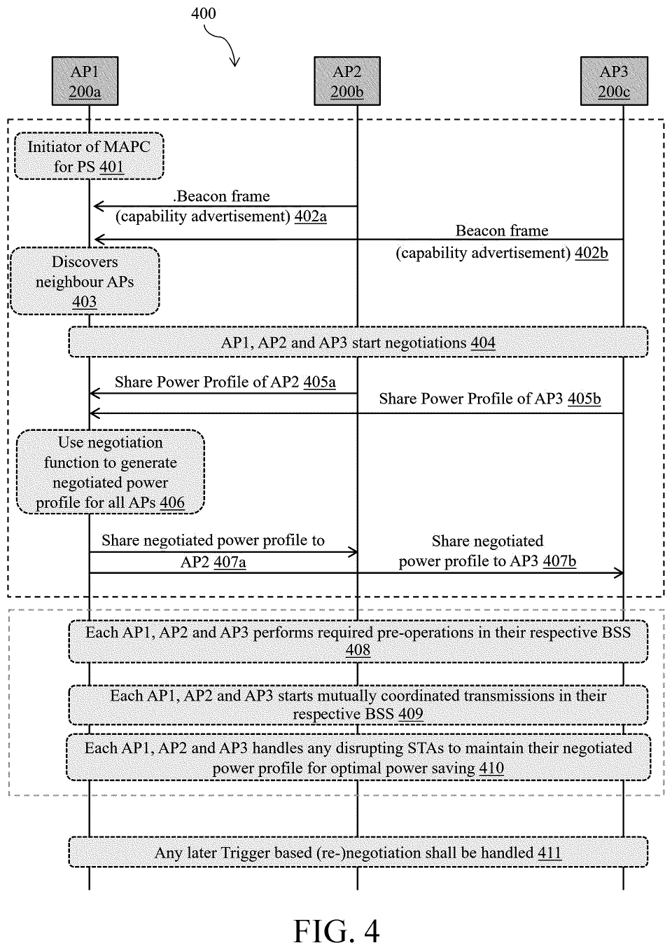

In various example embodiments, the coordination module 240 may initiate, at a primary AP, a Multi-AP Coordination for AP Power Saving (MAPC for AP PS) scheme, for the plurality of APs, based on one or more trigger parameters associated with the primary AP, as described in conjunction with FIG. 3 and FIG. 4. The one or more trigger parameters may include, for example, but are not limited to, traffic profile data, power-saving requirements, and any additional triggers applicable to at least one of an enterprise environment and a non-enterprise environment.

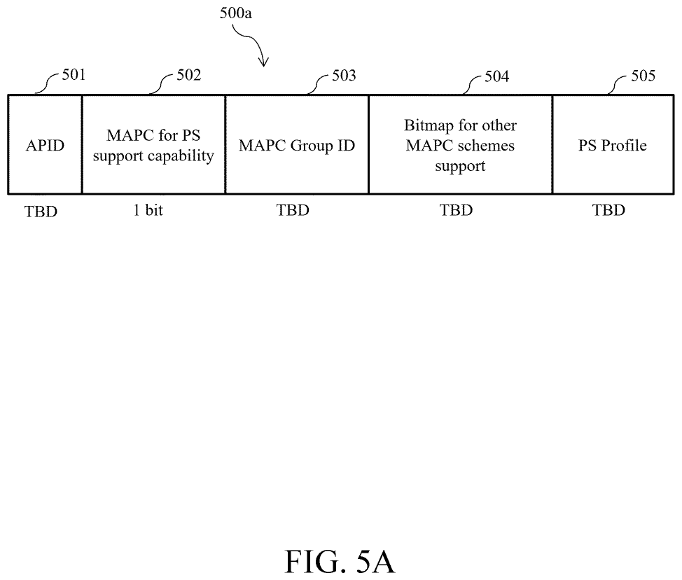

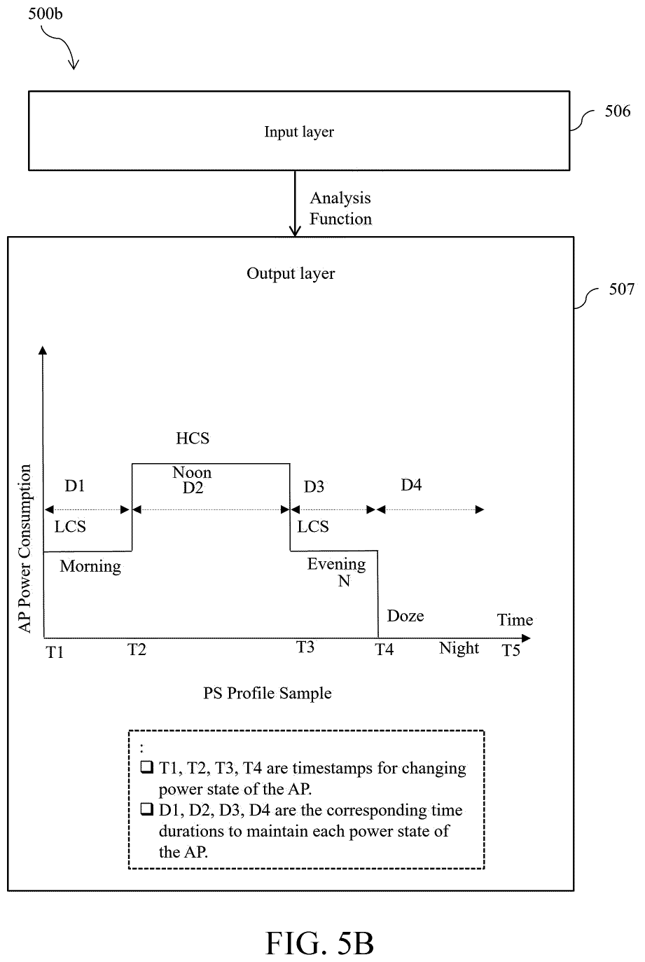

In various example embodiments, the coordination module 240 may receive one or more broadcast frames from each of a plurality of secondary APs among the plurality of APs. The one or more broadcast frames comprise capability information corresponding to the secondary AP. The capability information may include, for example, but is not limited to, an identity of AP, an MAPC for PS support capability, an MAPC group identity, a bitmap for other MAPC schemes supported, and a PS profile of the AP, as described in conjunction with FIGS. 5A-5B.

In various example embodiments, the coordination module 240 may identify one or more neighbor APs from the plurality of secondary APs based on the received capability information. The coordination module 240 may perform one or more negotiation operations with the one or more identified neighbor APs to establish coordination between the primary AP and the one or more identified neighbor APs for coordinated data communication in the MAPC for AP PS scheme, as described in conjunction with FIG. 3 to FIG. 10. The one or more negotiation operations may include various operations, which are given below.

In various example embodiments, the coordination module 240 may receive a power profile from each of the one or more identified neighbor APs, as described in conjunction with FIG. 5A. In an embodiment, the power profile is obtained from an optional bitmap for Power Saving (PS) profile included in the received capability information. In an embodiment, the power profile is received through a dedicated signalling during the one or more negotiation operations.

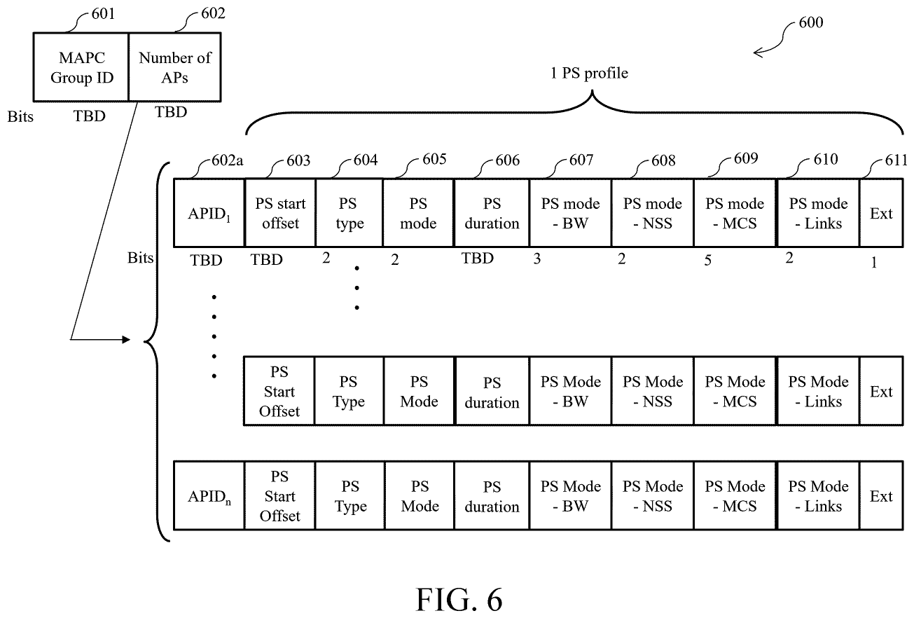

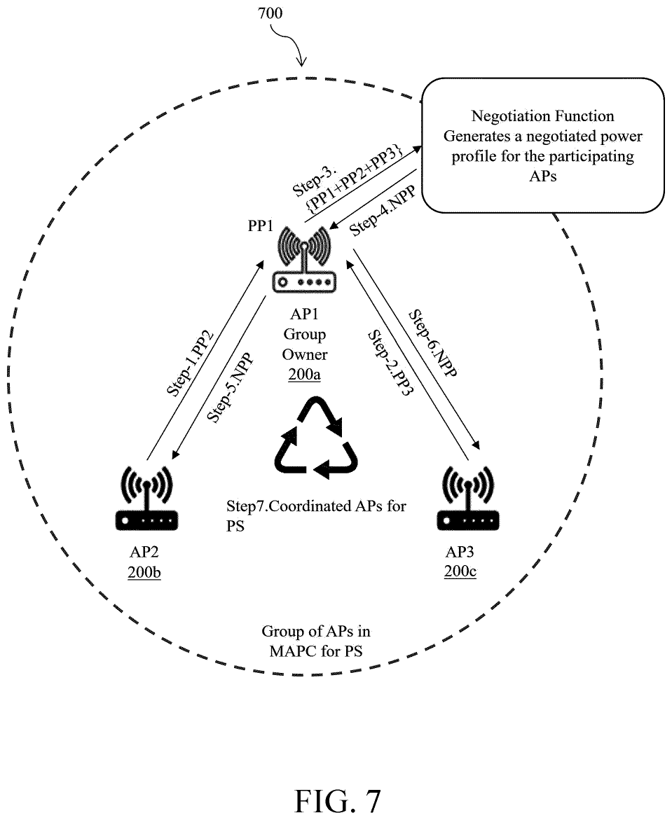

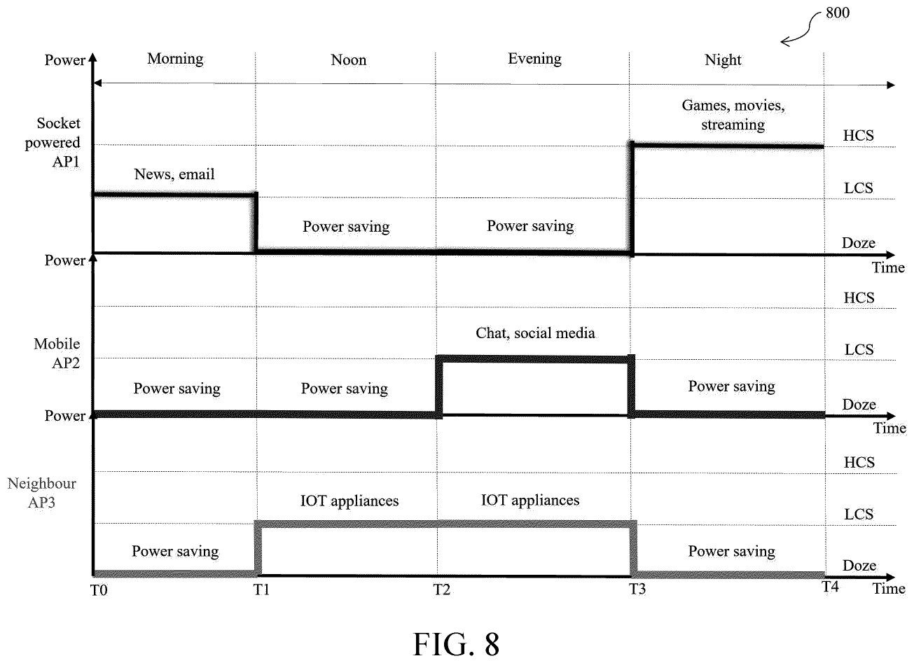

In various example embodiments, the coordination module 240 may analyze the received power profile using a negotiation function implemented either at the primary AP or a Backend Distribution system (DS) of the AP 200. The coordination module 240 may further generate an optimal Negotiated PS Profile (NPP), for each of the one or more identified neighbor APs including the primary AP, based on at least one of the results of analysis and meeting one or more predefined criteria for NPP policies, as described in conjunction with FIG. 6, FIG. 7, and FIG. 8. The optimal NPP may include, for example, but is not limited to, an MAPC group identity, a number of APs, an identity of AP, a PS start offset, a PS type, a PS mode, a PS duration, a PS mode bandwidth, a PS mode Number of Spatial Streams (NSS), a PS mode Modulation and Coding Scheme (MCS), a PS mode link, and an extension bit. The coordination module 240 may further transmit the generated optimal NPP to the one or more corresponding identified neighbor APs.

In various example embodiments, the coordination module 240 may determine whether the one or more negotiation operations have been completed within a Coordination Window (CW) timer. The primary AP initiates the CW timer at the time of initiation of the MAPC for AP PS scheme. In response to determining that the one or more negotiation operations have been completed within the CW timer, the coordination module 240 may initiate a Guard Window (GW) timer, as described in conjunction with FIG. 3 and FIG. 4. In response to initiating the GW timer, the coordination module 240 may establish the coordination between the primary AP and the one or more identified neighbor APs for the coordinated data communication aiming the MAPC for AP PS scheme.

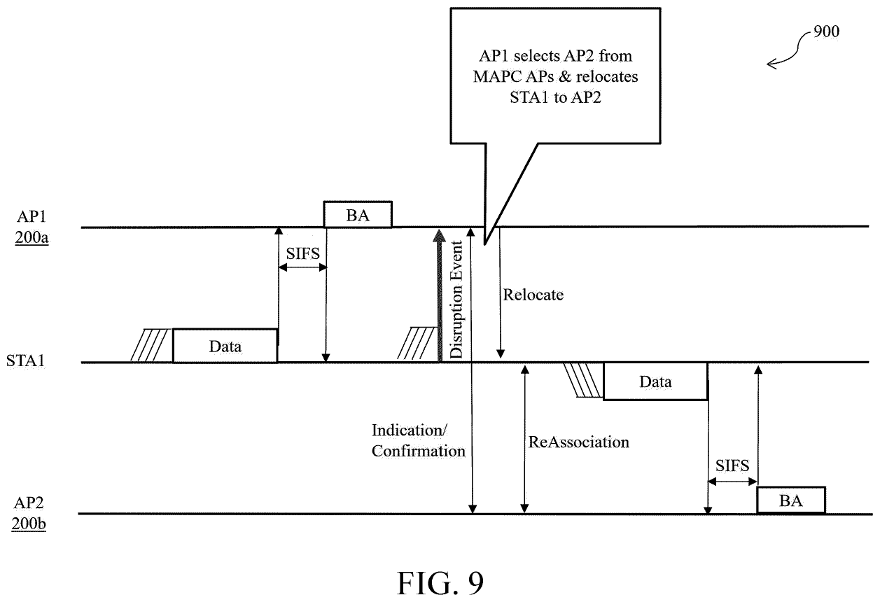

In various example embodiments, the coordination module 240 may determine whether the coordinated transmissions have started within the GW timer. After the expiration of the GW timer, the coordination module 240 may handle one or more trigger conditions, that are either periodic, aperiodic, or event-based, that lead to a re-negotiation procedure associated with the plurality of secondary APs, as described in conjunction with FIG. 3, FIG. 4, and FIG. 9.

Although FIG. 2 shows various hardware components of the AP 200, but it is to be understood that various embodiments are not limited thereto. In various embodiments, the AP 200 may include less or more number of components. Further, the labels or names of the components are used for illustrative purposes and do not limit the scope of the disclosure. One or more components can be combined to perform the same or substantially similar functions for establishing the coordination between the plurality of APs in the wireless network.

FIG. 3 is a diagram illustrating a plurality of phases 300 associated with the AP 200 to establish the coordination between the plurality of APs, according to various embodiments. The plurality of phases 300 may include an Initiation (of MAPC for PS scheme) 301, a discovery phase 302, a negotiation phase 303, a pre-operations at M-APs (before coordinated transmissions) 304, and a handling of non-AP MLDs (during coordinated PS periods) 305. FIG. 3 illustrates example processes involved in the implementation of the present disclosure. The description provided for all the figures from FIGS. 2 to 10 is to be read collectively and FIG. 3 illustrates the overall process for ensuring the coordination among multiple APs for Power Saving (PS).

In various example embodiments, the CW may include a predefined time period during which the primary AP waits for one or more responses from the one or more identified neighbor APs to participate in the one or more negotiation operations to establish coordination between the primary AP and the one or more identified neighbor APs.

In various example embodiments, the GW may include a predefined time period during which coordinated APs implement one or more agreements and operate smoothly via coordinated state and transmissions within the wireless network, to prevent/reduce one or more non-participating APs from disrupting the coordination by trying to participate in the ongoing MAPC for AP PS scheme until the GW has expired.

FIG. 4 is a signal flow diagram illustrating an example method 400 for establishing Multi-AP (M-AP) coordination for AP PS in an Ultra High Reliability (UHR), according to various embodiments. The method 400 may execute multiple operations to establish the M-AP coordination for AP PS in the UHR, which are described below.

At operation 401, the method 400 includes identifying, by an AP1 200a (e.g., primary AP), a need to initiate the MAPC for AP PS scheme based on its traffic demands, power-saving requirements, or other triggers, which may relate to Initiation (of MAPC for PS scheme) 301. This can occur in both enterprise and non-enterprise environments. At operation 402a, the method 400 includes transmitting, by an AP2 200b (e.g., secondary AP), its capability to support the MAPC for AP PS scheme by sending a beacon frame or a unicast probe response to the AP1 200a in operation 402a. This beacon frame includes specific “support bits” indicating its capabilities. At operation 402b, the method 400 includes transmitting, by an AP3 200c (e.g., secondary AP), the beacon frame or unicast probe response to the AP1 200a, sharing its own “support bits” for the MAPC for AP PS scheme.

At operation 403, after receiving the capability information from the AP2 200b and AP3 200c, the method 400 includes decoding, by the AP1 200a, the management frames (e.g., beacons) to confirm that both APs can participate in the MAPC for AP PS scheme, or said discovering both APs. At operation 404, the method 400 includes initiating, by the AP1 200a, a negotiation process (one or more negotiation operations) with the AP2 200b and AP3 200c. This can be triggered by a multicast frame sent from the AP1 200a, setting the stage for further coordination.

At operation 405a, the method 400 includes transmitting, by the AP2 200b, its own power profile information (e.g., PP2) to the AP1 200a, detailing how the AP2 200b manages power. At operation 405b, the method 400 includes transmitting, by the AP3 200c, its own power profile information (e.g., PP3) to the AP1 200a, detailing how the AP3 200c manages power. At operation 406, the method 400 includes processing, by the AP1 200a, the power profiles received from the AP2 200b and AP3 200c and uses a negotiation function to create an optimal power profile (e.g., an optimal NPP) for all participating APs (e.g., the AP1 200a, the AP2 200b, and the AP3 200c).

At operation 407a, the method 400 includes transmitting, by the AP1 200a, the negotiated power profile back to the AP2 200b. At operation 407b, the method 400 includes transmitting, by the AP1 200a, the negotiated power profile back to the AP3 200c, ensuring all APs are aligned on the power-saving strategy (MAPC for AP PS scheme). Operation 401 through 407b occur within the CW, where only the APs identified during this period are involved in the coordination process.

At operation 408, the method 400 includes performing, by each AP (e.g., the AP1 200a, the AP2 200b, and the AP3 200c), necessary preparations in their respective Basic Service Sets (BSS). This includes notifying their connected client stations about their sleep schedules. At operation 409, following the preparations the method 400 includes initiating, by each AP (e.g., the AP1 200a, the AP2 200b, and the AP3 200c), coordinated data transmissions within their BSSs, optimizing power usage. At operation 410, the method 400 includes monitoring and managing, by each AP, any disrupting station (STA) to ensure that their negotiated power profiles are upheld for optimal power savings. Operations 408 through 410 take place within the GW, allowing for adjustments and management of ongoing operations. At operation 411, even after the GW ends, the method 400 includes participating APs (e.g., the AP1 200a, the AP2 200b, and the AP3 200c) remain capable of responding to any trigger conditions that may necessitate re-negotiation of the coordination scheme, ensuring continued efficiency in the MAPC for AP PS scheme.

FIG. 5A is a diagram illustrating an example structure of a minimal set of information element to be broadcasted in Beacon or Probe Response frames 500a associated with the AP 200, according to various embodiments. The broadcast frame structure 500a includes capability information corresponding to the secondary AP. The capability information may include, for example, but is not limited to, the identity of AP 501, the MAPC for PS support capability 502, the MAPC group identity 503, the bitmap for other MAPC schemes supported 504, and the PS profile 505 of the AP 200 (e.g., 200b, 200c, etc.).

In various example embodiments, the identity of AP 501 (e.g., an actual or virtual APID) identifies each AP uniquely during an MAPC for PS configuration and signalling with other APs (e.g., 200b, 200c, etc.).

In various example embodiments, the MAPC for PS support capability 502 indicates support for the MAPC for AP PS scheme.

In various example embodiments, the MAPC group identity 503 indicates a valid Group ID when the AP is part of a previously configured MAPC for the AP PS group. In other words, If the current AP is already part of a previously configured MAPC for the PS group, then the valid group ID else a NULL value as group ID.

In various example embodiments, the bitmap for other MAPC schemes support 504 indicates a support of one or more other type of MAPC coordination schemes. The one or more other type of MAPC coordination schemes may include, for example, but is not limited to, a Coordinated Time Division Multiple Access (Co-TDMA), a Coordinated Restricted Target Wakeup Time (Co-RTWT), a Coordinated Spatial Reuse (Co-SR), a Coordinated Beam Forming (Co-BF), a Coordinated Joint Transmissions (C-JT), and a Coordinated Access Points (C-AP).

In various example embodiments, the one or more other type of MAPC coordination schemes may be utilized, in coordination with other APs (e.g., 200b, 200c, etc.), during the awake or active period of the AP 200 for efficient transmissions and optimal channel utilization as per existing coordination methods being discussed in research and industry.

Including such MAPC scheme information additionally, in the elements of MAPC for PS signalling, helps to ensure the feasibility of a unified framework that can be used for most of the coordination schemes including both the low power as well as high power states of the AP 200.

In various example embodiments, the PS profile 505 indicates information related to AP PS requirements and comprises one or more additional supplementary elements. The one or more additional supplementary elements may include, for example, but are not limited to, a traffic pattern, a sleep pattern, an awake pattern, a Quality of Service (QOS) requirement, AP's High Capability State (HCS), or Low Capability State (LCS) support and corresponding application pattern. In other words, the PS profile 505 indicates an optional bitmap (optional in the sense of whether to keep it in discovery signalling or in negotiation signalling) named PS Profile (PP) which actually provides the information related to PS requirements and may contain additional supplementary elements such as projected traffic pattern, sleep/awake pattern, QoS requirements, AP's LCS/HCS capability support and applying a pattern, etc. Such information may be actually used to create the optimally coordinated PS patterns/cycles for the participating APs (e.g., the AP1 200a, the AP2 200b, and the AP3 200c).

In various example embodiments, the capability information is broadcasted by utilizing a management frame using at least one of a beacon frame or probe request/response frames. Discovery-related signalling can also be realized over a wired or wireless backhaul link between APs if coordinating APs belong to the same enterprise network.

FIG. 5B is a diagram illustrating an example scenario 500b where the AP 200 configures its PS profile based on its power saving requirements, according to various embodiments. The purpose of creating/configuring the PS profile of the AP 200 is to generate an information set that is the closest approximation to the power-saving needs of the AP 200 including the ‘time of applying and duration’ for the elements as captured in the output layer 507 of PS Profile configuration in FIG. 5B. To create the PS profile with the above information set, it must take into account and evaluate at least the parameters captured in input layer 506 of the PS profile configuration in FIG. 5B. The evaluation function aka Analysis Function can be realized either at the AP 200 itself or the backend system at DS.

In some example embodiments, at operation 506 (refer to input layer), the coordination module 240 may determine one or more evaluation parameters associated with the AP 200 by utilizing at least one of the data analytics functions.

In various example embodiments, the one or more evaluation parameters are determined based on, for example, but not limited to, an analysis of user density and traffic patterns served by the AP at various time periods (e.g., daily/weekly/monthly), an identification of at least one of a static characteristic and a dynamic characteristic of one or more data patterns, an analysis of link-level data usage for Multi-Link Devices (MLD AP) (e.g., 2.4 GHz, 5 GHZ, 6 GHZ), a Quality of Service (QOS) requirement associated with the one or more data patterns (e.g., voice, data types, background traffic), a load balancing requirement, an analysis of data generation and corresponding operational time patterns for different types of standard wireless communication enabled devices, and an analysis of power-saving requirements based on one or more AP device type classifications (e.g., soft AP, mobile AP, battery-powered, socket powered).

In various example embodiments, the one or more evaluation parameters are determined based on advanced data analysis, learning, and prediction or AI as per contemporary advancements.

In various example embodiments, at operation 507 (refer to output layer), the coordination module 240 may configure the PS profile based on the one or more determined evaluation parameters. The PS profile may include, for example, but is not limited to, a low-power state and a high-power state and corresponding validity duration.

In some example embodiments, one or more elements in the output layer of PS profile configuration may include information related to the low-power state (doze/sleep/LCS), the high-power state (full awake, HCS), and associated information related to the validity duration. Validity duration relates to how frequently the system 201 as disclosed needs to re-evaluate and re-negotiate the PS profile. In an example, as illustrated in FIG. 5B as a power-saving profile sample, the AP 200 in corporate office premises may oversee low traffic in the early mornings, high traffic in the major part of the day, low traffic in the evening time, and no traffic at late night time. Further, in FIG. 5B, T1, T2, T3, and T4 are the timestamps for changing the power state of the AP 200. D1, D2, D3, and D4 are the corresponding time durations to maintain each power state of the AP 200.

FIG. 6 is a diagram illustrating an example optimal NPP frame structure 600 associated with the AP 200 participating in the MAPC for AP PS scheme, according to various embodiments.

The optimal NPP frame structure 600 may contain the negotiated PS profile of each participating AP (e.g., the AP1 200a, the AP2 200b, and the AP3 200c), and this information is shared with all those APs. The optimal NPP frame structure 600 may include, for example, but is not limited to, the MAPC group identity 601, the number of APs 602, an identity of AP (e.g., the identity of AP1 602a, the identity of APn 602n (not shown in FIG. 6)), the PS start offset 603, the PS type 604, the PS mode 605, the PS duration 606, the PS mode bandwidth 607, the PS mode NSS 608, the PS mode MCS 609, the PS mode link 610, and the extension bit 611.

In various example embodiments, the MAPC group identity 601 indicates a unique group identifier for the plurality of APs coordinating in the MAPC for AP PS scheme.

In various example embodiments, the number of APs 602 indicates a total count of the plurality of APs in the MAPC for AP PS scheme. The PS profiles may follow starting with the corresponding AP1D (identifier).

In various example embodiments, the PS start offset 603 indicates an initial padding delay required for a configuration and application of the PS profile.

In various example embodiments, the PS type 604 indicates a 2-bit field that specifies the PS type, including one or more type options (e.g., off, scheduled, dynamic, etc.).

In various example embodiments, the PS mode 605 indicates a 2-bit field that specifies the PS mode, including one or more states (e.g., doze, awake, LCS, HCS, etc.).

In various example embodiments, the PS duration 606 indicates a total duration for which the PS profile is to be applied.

In various example embodiments, the PS mode bandwidth 607 indicates a 3-bit identifier representing a total Overlapping Basic Service Set (OBSS) bandwidth supported by the AP 200 for a current PS profile.

In various example embodiments, the PS mode NSS 608 indicates a 2-bit identifier representing a total number of spatial streams supported by the AP 200 in the current PS profile.

In various example embodiments, the PS mode MCS 609 indicates a 5-bit identifier representing a maximum modulation and coding scheme supported by the AP 200 in the current PS profile.

In various example embodiments, the PS mode link 610 indicates a 2-bit identifier representing one or more links supported by the AP 200 in the current PS profile.

In various example embodiments, the extension bit 611 indicates a 1-bit identifier representing a type of the PS scheme that is executed next in sequential order for the same AP 200. If there is more than one type of PS scheme (to be applied in sequence such as an LCS followed by HCS) identified in advance, then multiple PS profiles for the same AP 200 may be appended using the extension bit 611.

In various example embodiments, the coordination module 240 may determine whether a value of the extension bit is set to one or zero. In response to determining that the value of the extension bit is set to one, the coordination module 240 may initiate a subsequent PS profile immediately upon the completion of the current PS profile for the same AP 200. In response to determining that the value of the extension bit is set to zero, the coordination module 240 may terminate the current PS profile, followed by the PS profile for a next identity of AP 200 in the NPP. At the end of the last PS profile duration of the AP 200, its PS profiles may be cycled again starting from its first profile unless there is a need for a fresh negotiation, in which case it may proceed with corresponding signalling and get updated NPP accordingly.

FIG. 7 is a diagram illustrating an example implementation of the negotiation process 700 (negotiation 303) using the PS profile, according to various embodiments. The negotiation process 700 is performed by the coordination module 240 after the discovery 302 as shown in FIG. 3 and FIG. 4. Further, a detailed description related to the various steps of FIG. 7 is covered in the description related to FIG. 4 and may not be repeated here for the sake of brevity.

In various example embodiments, after the APs of interest discover each other, one from among the APs (e.g., 200a, 200b, and 200c) is designated as the group owner (e.g., the AP1 200a). In an example, the initiator AP (e.g., the AP1 200a) may be designated as the group owner.

In various example embodiments, based on a random ranking (with equal probability), any other participating AP may be designated as the group owner (e.g., the AP1 200a).

In various example embodiments, in the negotiation process 700, the PS profile of all the APs (e.g., 200a, 200b, and 200c) including that of the group owner AP (e.g., the AP1 200a) may be used for further negotiation purposes through a negotiation function. The other APs' PS profile (e.g., PP1, PP2, and PP3) is acquired either through all participating APs' broadcasted discovery message contents or through subsequent signalling related to the negotiation phase 303.

In various example embodiments, the negotiation function may reside at the group owner AP (e.g., the AP1 200a) itself or at a backend distributed system (DS). In an example, steps related to authentication of the APs (once/every-time authentication) may be introduced to ensure that the information is shared across trusted and reliable APs only.

In various example embodiments, the negotiation function shall generate the NPP by analyzing the PS Profiles of all the participating APs (e.g., 200a, 200b, and 200c). The negotiation function is further responsible for informing the NPP to the APs (e.g., 200b, and 200c). An example set of conditions to be followed by the network function for generating the NPP (the one or more predefined criteria for NPP policies), which are given below.
a. The coordination module 240 may determine whether a unique MAPC group identity is assigned for use by the plurality of APs (e.g., 200a, 200b, and 200c).
b. The coordination module 240 may determine whether an equal opportunity is provided for power conservation to each of the plurality of APs (e.g., 200a, 200b, and 200c).
c. The coordination module 240 may determine whether at least one OBSS AP is present in the HCS power state based on at least one traffic pattern demand.
d. The coordination module 240 may determine whether the at least OBSS AP is present in the LCS power state based on the at least one traffic pattern demand.
e. The coordination module 240 may determine whether an overlapping region with the at least one OBSS AP in an awake state exists at any time instance to avoid one or more coverage holes.
f. The coordination module 240 may determine whether one or more PS profile patterns are optimized and allocate the NPP back to the plurality of APs (e.g., 200a, 200b, and 200c).

In various example embodiments, the coordination module 240 may perform, after the negotiation process 700 (negotiation 303), one or more operations, related to pre-operations at M-APs (before coordinated transmissions) 304 as shown in FIG. 3 and FIG. 4, which are mentioned below.
a. Each of the primary AP (e.g., 200a) and the one or more participating APs (e.g., 200b, and 200c) apply individual NPP profiles within respective BSS.
b. Each of the primary AP (e.g., 200a) and the one or more participating APs (e.g., 200b, and 200c), in an active state, apply any other configured MAPC schemes within respective BSS during coordinated transmissions.
c. Each of the primary AP (e.g., 200a) and the one or more participating APs (e.g., 200b, and 200c) updates the valid MAPC group identifier in corresponding MAPC group-related broadcast information in the corresponding capability element.
d. Each of the primary AP (e.g., 200a) and the one or more participating APs (e.g., 200b, and 200c) ensures to inform associated client devices/stations (STAs) about the AP's configured PS profiles or states and corresponding availability information.
e. Each of the primary AP (e.g., 200a) and the one or more identified neighbor APs (e.g., 200b, and 200c) initiates coordinated transmissions within respective BSS.
f. Each of the primary AP (e.g., 200a) and the one or more identified neighbor APs (e.g., 200b, and 200c) handles any disrupting client or station (STA) to protect and maintain a negotiated power profile for optimal power saving.

In various example embodiments, the coordinating M-APs may be responsible for informing the non-AP MLDs or STAs being served by them about the configured power-saving pattern of the serving AP (e.g., 200a) at the earliest possible TXOP or multicast/broadcast in the management frames such as beacon or probe request/response frames to ensure that non-AP MLDs or STAs are made aware in advance about the availability states of the serving AP (e.g., 200a).

In various example embodiments, in the context of triggers for (re-) negotiation, there are several types of triggers that the AP 200 can use to initiate the MAPC for PS negotiations or re-negotiations, especially in non-enterprise environments where conditions can change frequently. These triggers may include:
a. Periodic triggers: For instance, the AP 200 may re-negotiate the NPP after a specified time interval expires.
b. Aperiodic or event-based triggers: For instance, a mobile battery-powered AP 200 might initiate a re-negotiation if its battery level falls below a certain threshold. If there is a sudden increase in client load either in the number of clients or the amount of traffic that the AP 200 is handling compared to its normal capacity this could also trigger the re-negotiation, on a daily/periodic/predicted basis.

FIG. 8 is a diagram illustrating example power consumption over time in an example use-case 800 of an implementation of a Negotiated Power saving Profile (NPP) in a residential scenario, according to various embodiments,

In the example use-case illustrated in FIG. 8, a first Access Point (AP1) is a socket-powered AP, a second Access Point (AP2) is a portable Wi-Fi device with cellular backhaul connectivity and Wi-Fi fronthaul capabilities, and a third Access Point (AP3) is a mobile hotspot neighbor AP. These APs are organized into a group in accordance with the example embodiments outlined in the present disclosure to implement MAPC for PS. FIG. 8 illustrates the dynamic switching of the APs to the HCS, the LCS, and doze modes, based on coordinated power-saving strategies as per the example embodiments described herein. Power consumption and coordinated power-saving measures are demonstrated across various times of the day, including morning, noon, evening, and night.

In various example embodiments, the system 201 is configured to facilitate the pairing of APs based on traffic types, such as voice, data, and background traffic. This embodiment further discloses a method to satisfy the QoS requirements of STAs served by the coordinated APs within the MAPC for PS group. In this embodiment, the APs negotiate and allocate users and traffic among themselves based on traffic type and QoS requirements.

As illustrated in FIG. 8, the residential home APs (AP1, AP2, and AP3) may be configured to coordinate for “datatype-AP binding”. For instance, the AP1 could be designated to handle high QoS data, such as streaming, movies, gaming, and 4K content, operating in the HCS. The AP2 might manage medium QoS data, including email, chat, and browsing, while the AP3 may cater to low QoS data, such as IoT devices and meter readings, operating in the LCS. Further, in the example, in the event, the APs are in an active state with the above kind of power state coordination, an ad-hoc STA can be redirected to an AP according to application/data type requirements.

FIG. 9 is a diagram illustrating an example use-case scenario 900 where a first AP (AP1) 200a allocates a disrupting station to a second AP (AP2) 200b, according to various embodiments. FIG. 9 illustrates the use-case scenario 900, wherein the participating APs (e.g., 200a and 200b) start their corresponding coordinated power-saving cycles which comprise the low-power consumption and high-power consumption states correspondingly to support the coordinated data transmissions. In the example use-case scenario 900, during the coordinated duration of PS and data transmissions, there may arise a need to handle multiple types of client devices and their data traffic in real-time. The present disclosure provides efficient mechanisms with the overall aim of minimizing/reducing the latency of service, maximizing/increasing the throughput, and meeting the QoS while strictly following the coordinated PS cycles for optimal power saving (e.g., avoiding the disruption to the ongoing PS cycle of serving AP (e.g., 200a)).
a. In the use-case scenario 900, a disrupting STA (stationary or in mobility) may be an STA that may lose service if serving the AP1 200a anticipates going into the doze/sleep state.
b. In the use-case scenario 900, the disrupting STA may not be serviceable (QoS not met) in the current capability state of serving AP1 200a.
c. In the use-case scenario 900, disrupting STA may be STAs causing higher load on serving AP1 200a causing a need for load balancing, and similar scenarios.

In the present example use-case scenario 900 as illustrated in FIG. 9, a serving AP1 200a can relocate a disrupting STA to another (MAPC for PS coordinated) AP2 200b. In the present use-case scenario 900 implementation of the present disclosure, the AP2 200b is configured to meet the requirements of the disrupting STA. In accordance with example embodiments of the present disclosure, efficient relocation is possible as AP1 200a is aware of the AP2 200b's capability and power-saving cycle as they are both part of a negotiated and coordinated group.

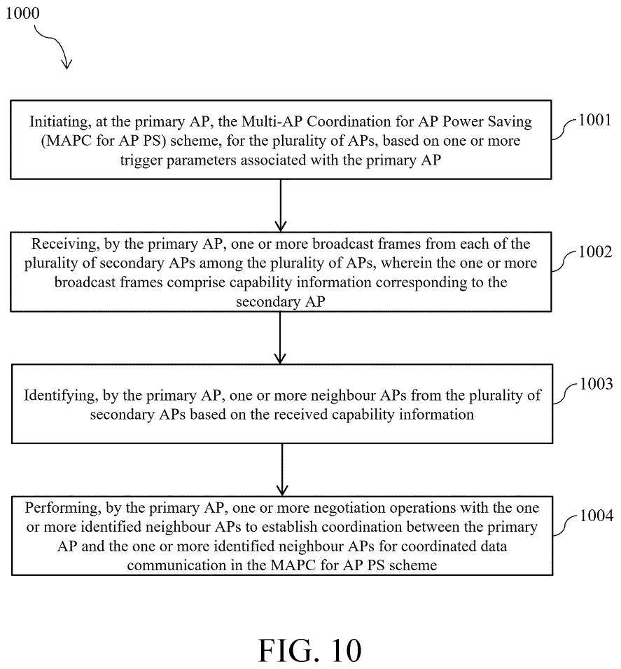

FIG. 10 is a flowchart illustrating an example method 1000 for establishing the coordination between the plurality of APs (e.g., 200a, 200b, and 200c) in the wireless network, according to various embodiments. The method 1000 may execute multiple operations to establish the coordination between the plurality of APs (e.g., 200a, 200b, and 200c) in the wireless network, which are given below.

At operation 1001, the method 1000 includes initiating, at the primary AP 200a, the MAPC for AP PS scheme, for the plurality of APs (e.g., 200a, 200b, and 200c), based on one or more trigger parameters associated with the primary AP 200a. At operation 1002, the method 1000 includes receiving, by the primary AP 200a, one or more broadcast frames from each of a plurality of secondary APs (e.g., 200b, and 200c) among the plurality of APs (e.g., 200a, 200b, and 200c), wherein the one or more broadcast frames comprise capability information corresponding to the secondary AP (e.g., 200b or 200c). At operation 1003, the method 1000 includes identifying, by the primary AP 200a, the one or more neighbor APs from the plurality of secondary APs (e.g., 200b and 200c) based on the received capability information. At operation 1004, the method 1000 includes performing, by the primary AP 200a, the one or more negotiation operations with the one or more identified neighbor APs (e.g., 200b and/or 200c) to establish coordination between the primary AP 200a and the one or more identified neighbor APs (e.g., 200b and/or 200c) for coordinated data communication in the MAPC for AP PS scheme. Further, a detailed description related to the various operations of FIG. 10 is covered in the description related to FIG. 2 to FIG. 9, and may not be repeated here for the sake of brevity.

In various example embodiments, the disclosed method/AP 200 has several advantages over the existing method, which are stated below.
a. Protection during low activity periods: Unlike current M-AP coordination schemes, which lack protection during doze, inactive, or low capability states of APs, the disclosed method/AP 200 addresses these critical periods that are essential for effective power saving.
b. Enhanced power-saving solutions: The disclosed method/AP 200 provides a comprehensive approach to power saving for the AP 200, aligning with the key functional requirements of the next-generation Wi-Fi 8 standards.
c. Achievement of UHR KPIs: The disclosed method/AP 200 facilitates the attainment of desired UHR KPIs for power saving in Wi-Fi 8 standards.
d. Coordinated power saving among APs: The disclosed method/AP 200 establishes a framework for coordinated power saving among neighboring APs (e.g., 200b and 200c), reducing interruptions and optimizing simultaneous channel usage.
e. Management of disruptive events: The disclosed method/AP 200 effectively addresses power-saving disruptions caused by non-AP Multi-Link Devices (MLDs) or Stations (STAs) during coordinated power-saving periods for participating APs (e.g., 200a and 200b).

The various actions, acts, blocks, steps, or the like in the flow diagrams may be performed in the order presented, in a different order, or simultaneously. Further, in various embodiments, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to on skilled in the art, various working modifications may be made to the method to implement the disclosure as taught herein. The drawings and the forgoing description give examples of embodiments. Those skilled in the art will appreciate that one or more of the described elements may well be combined into a single functional element. Certain elements may be split into multiple functional elements. Elements from one embodiment may be added to another embodiment.

The various example embodiments disclosed herein can be implemented using at least one hardware device and performing network management functions to control the elements.

What is claimed is:

1. A method for establishing coordination between a plurality of Access Points (APs) in a wireless network, the method comprising:
initiating, at a primary AP, a Multi-AP Coordination for AP Power Saving (MAPC for AP PS) scheme, for the plurality of APs, based on one or more trigger parameters associated with the primary AP;
receiving, by the primary AP, one or more broadcast frames from each of a plurality of secondary APs among the plurality of Aps, wherein the one or more broadcast frames comprise capability information corresponding to the secondary AP;
identifying, by the primary AP, one or more neighbor APs from the plurality of secondary APs based on the received capability information; and
performing, by the primary AP, one or more negotiation operations with the one or more identified neighbor APs to establish coordination between the primary AP and the one or more identified neighbor APs for coordinated data communication in the MAPC for AP PS scheme.

2. The method as claimed in claim 1, wherein performing the one or more negotiation operations comprises:
receiving, by the primary AP, a power profile from each of the one or more identified neighbor APs,
wherein the power profile is obtained from an optional bitmap for Power Saving (PS) profile included in the received capability information, or
wherein the power profile is received through a dedicated signalling during the one or more negotiation operations;
analyzing, by the primary AP, the received power profile by using a negotiation function implemented either at the primary AP or a Backend Distribution system (DS) of the AP;
generating, by the primary AP, an optimal Negotiated PS Profile (NPP), for each of the one or more identified neighbor APs including the primary AP, based on at least one of a result of analysis or meeting one or more specified criteria for NPP policies; and
transmitting, by the primary AP, the generated optimal NPP to the one or more corresponding identified neighbor APs

3. The method as claimed in claim 2, wherein the optimal NPP comprises one or more of an MAPC group identity, a number of APs, an identity of AP, a PS start offset, a PS type, a PS mode, a PS duration, a PS mode bandwidth, a PS mode Number of Spatial Streams (NSS), a PS mode Modulation and Coding Scheme (MCS), a PS mode link, and an extension bit.

4. The method as claimed in claim 3,
wherein the MAPC group identity indicates a unique group identifier for the plurality of APs coordinating in the MAPC for AP PS scheme;
wherein the number of APs indicates a total count of the plurality of APs in the MAPC for AP PS scheme;
wherein the PS start offset indicates an initial padding delay required for a configuration and application of the PS profile;
wherein the PS type indicates a 2-bit field that specifies the PS type, including one or more type options;
wherein the PS mode indicates a 2-bit field that specifies the PS mode, including one or more states;
wherein the PS duration indicates a total duration for which the PS profile is to be applied;
wherein the PS mode bandwidth indicates a 3-bit identifier representing a total Overlapping Basic Service Set (OBSS) bandwidth supported by the AP (200) for a current PS profile;
wherein the PS mode NSS indicates a 2-bit identifier representing a total number of spatial streams supported by the AP in the current PS profile;
wherein the PS mode MCS indicates a 5-bit identifier representing a maximum modulation and coding scheme supported by the AP in the current PS profile;
wherein the PS mode link indicates a 2-bit identifier representing one or more links supported by the AP in the current PS profile; and
wherein the extension bit indicates a 1-bit identifier representing a type of the PS scheme that is executed next in sequential order for the same AP.

5. The method as claimed in claim 4, comprising:
determining whether a value of the extension bit is set to one or zero; and
performing one of:
in response to determining that the value of the extension bit is set to one, initiating a subsequent PS profile immediately upon the completion of the current PS profile for the same AP; or
in response to determining that the value of the extension bit is set to zero, terminating the current PS profile, followed by the PS profile for a next identity of AP in the NPP.

6. The method as claimed in claim 2, wherein the one or more specified criteria for NPP policies comprises:
determining whether a unique MAPC group identity is assigned for use by plurality of APs;
determining whether an equal opportunity is provided for power conservation to each of the plurality of APs;
determining whether at least one Overlapping Basic Service Set (OBSS) AP is present in a High Capability State (HCS) power state based on at least one traffic pattern demand;
determining whether the at least OBSS AP is present in a Low Capability State (LCS) power state based on the at least one traffic pattern demand;
determining whether an overlapping region with the at least one OBSS AP in awake state exists at any time instance to avoid one or more coverage holes; and
determining whether one or more PS profile patterns are optimized and allocating the NPP back to the plurality of APs.

7. The method as claimed in claim 1, wherein the one or more trigger parameters comprise traffic profile data, power-saving requirements and any additional triggers applicable to one or more of an enterprise environment and a non-enterprise environment.

8. The method as claimed in claim 1, wherein the capability information comprises one or more of an identity of AP, an MAPC for PS support capability, an MAPC group identity, a bitmap for other MAPC schemes supported, and a PS profile of the AP.

9. The method as claimed in claim 8,
wherein the identity of AP identifies each AP uniquely during an MAPC for PS configuration and signalling with other APs;
wherein the MAPC for PS support capability indicates support for the MAPC for AP PS scheme;
wherein the MAPC group identity indicates a valid Group ID when the AP is part of a previously configured MAPC for AP PS group;
wherein the bitmap for other MAPC schemes support indicates a support of one or more other type of MAPC coordination schemes;
wherein the one or more other type of MAPC coordination schemes comprise one or more of a Coordinated Time Division Multiple Access (Co-TDMA), a Coordinated Restricted Target Wakeup Time (Co-RTWT), a Coordinated Spatial Reuse (Co-SR), a Coordinated Beam Forming (Co-BF), a Coordinated Joint Transmissions (C-JT), and a Coordinated Access Points (C-AP);
wherein the PS profile indicates information related to AP PS requirements and comprises one or more additional supplementary elements;
wherein the one or more additional supplementary elements comprise one or more of a traffic pattern, a sleep pattern, an awake pattern, a Quality of Service (QOS) requirement, AP's High Capability State (HCS) or Low Capability State (LCS) support and corresponding application pattern; and
wherein the capability information is broadcasted by utilizing a management frame using at least one of a beacon frame or probe request/response frames.

10. The method as claimed in claim 8, wherein the PS profile of the AP is configured by:
determining one or more evaluation parameters associated with the AP by utilizing at least one of data analytics functions and,
wherein the one or more evaluation parameters are determined based on one or more of an analysis of user density and traffic patterns served by the AP at various time periods, an identification of one or more of a static characteristic and a dynamic characteristic of one or more data patterns, an analysis of link-level data usage for Multi-Link Devices (MLD AP), a Quality of Service (QOS) requirement associated with the one or more data patterns, a load balancing requirement, an analysis of data generation and corresponding operational time patterns for different types of standard wireless communication enabled devices, and an analysis of power-saving requirements based on one or more AP device type classifications; and
configuring the PS profile based on the one or more determined evaluation parameters,
wherein the PS profile comprises one or more of a low-power state and a high-power state and corresponding validity duration.

11. The method as claimed in claim 1, further comprising:
determining, by the primary AP, whether the one or more negotiation operations has completed within a Coordination Window (CW) timer, wherein the primary AP initiates the CW timer at the time of initiation of the MAPC for AP PS scheme;
in response to determining that the one or more negotiation operations has completed within the CW timer, initiating, by the primary AP, a Guard Window (GW) timer; and
in response to initiating the GW timer, establishing the coordination between the primary AP and the one or more identified neighbor APs for the coordinated data communication aiming the MAPC for AP PS scheme,
wherein each of the primary AP and the one or more identified neighbor APs perform one or more required specified operations within a respective Basic Service Set (BSS),
wherein each of the primary AP and the one or more participating APs apply individual NPP profile within respective BSS,
wherein each of the primary AP and the one or more participating APs, in active state, apply any other configured MAPC schemes within respective BSS during coordinated transmissions,
wherein each of the primary AP and the one or more participating APs updates the valid MAPC group identifier in corresponding MAPC group related broadcast information in the corresponding capability element,
wherein each of the primary AP and the one or more participating APs ensures to inform associated client devices/stations (STAs) about the AP's configured PS profiles or states and corresponding availability information, and
wherein each of the primary AP and the one or more identified neighbor APs initiates coordinated transmissions within respective BSS, and
wherein each of the primary AP and the one or more identified neighbor APs handles any disrupting client or station (STA) to protect and maintain a negotiated power profile for optimal power saving.

12. The method as claimed in claim 11, further comprising:
determining, by the primary AP, whether the coordinated transmissions have started within the GW timer; and
after the expiration of the GW timer, handling, by the primary AP, one or more trigger conditions, that are either periodic, aperiodic or event based, that lead to a re-negotiation procedure associated with the plurality of secondary APs.

13. The method as claimed in claim 11, comprising:
wherein the CW is a specified time period during which the primary AP waits for one or more responses from the one or more identified neighbor APs to participate in the one or more negotiation operations to establish coordination between the primary AP and the one or more identified neighbor APs; and
wherein the GW is a specified time period during which coordinated APs implement one or more agreements and operate via coordinated state and transmissions within the wireless network, to prevent reduce one or more external APs from disrupting the coordination by trying to participate in the ongoing MAPC for AP PS scheme until the GW has expired.

14. The method as claimed in claim 11, wherein handling any disrupting STA comprises one or more operations, the one or more operations comprise:
determining, by a first AP among all the participating APs in MAPC for AP PS scheme, whether a service or state interruption occurs due to one or more STAs associated with a first AP or whether a service requirement of the one or more STAs associated with the first AP meets a specified service criteria; and
reallocating, by the first AP, the one or more STAs to a second AP among the one or more identified neighbor APs, which are all aware of neighbor AP's current PS profile and state of operations via coordination under the MAPC for AP PS scheme, to provide one or more network services, in response to determining that the service interruption occurs at one or more STAs associated with the first AP and the service requirement of the one or more STAs associated with the first AP does not meet the specified service criteria.

15. The method as claimed in claim 11, comprising:
performing, by the primary AP, one or more of negotiating and distributing user density and traffic among the one or more identified neighbor APs based on a type of traffic and a service requirement.

16. A primary Access Point (AP) for establishing coordination between a plurality of Access Points (APs) in a wireless network, the primary AP comprising:
at least one processor including processing circuitry; and
memory storing instructions that, when executed by the at least one processor individually or collectively, cause the primary AP to:
initiate a Multi-AP Coordination for AP Power Saving (MAPC for AP PS) scheme, for the plurality of APs, based on one or more trigger parameters associated with the primary AP;
receive one or more broadcast frames from each of a plurality of secondary APs among the plurality of APs, wherein the one or more broadcast frames comprise capability information corresponding to the secondary AP;
identify one or more neighbor APs from the plurality of secondary APs based on the received capability information; and
perform one or more negotiation operations with the one or more identified neighbor APs to establish coordination between the primary AP and the one or more identified neighbor APs for coordinated data communication in the MAPC for AP PS scheme.

17. The primary AP as claimed in claim 16, wherein to perform the one or more negotiation operations, the instructions, when executed by the at least one processor individually or collectively, cause the primary AP to:
receive a power profile from each of the one or more identified neighbor APs,
wherein the power profile is obtained from an optional bitmap for Power Saving (PS) profile included in the received capability information, or
wherein the power profile is received through a dedicated signalling during the one or more negotiation operations;
analyze the received power profile using a negotiation function implemented either at the primary AP or a Backend Distribution system (DS) of the primary AP;
generate an optimal Negotiated PS Profile (NPP), for each of the one or more identified neighbor APs including the primary AP, based on one or more of a result of analysis and meeting one or more specified criteria for NPP policies; and
transmit the generated optimal NPP to the one or more corresponding identified neighbor APs.

18. The primary AP as claimed in claim 16, wherein the one or more trigger parameters comprise traffic profile data, power-saving requirements and any additional triggers applicable to at least one of an enterprise environment and a non-enterprise environment.

19. The primary AP as claimed in claim 16, wherein the capability information comprises one or more of an identity of AP, an MAPC for PS support capability, an MAPC group identity, a bitmap for other MAPC schemes supported, and a PS profile of the primary AP.

20. The primary AP as claimed in claim 16, the instructions, when executed by the at least one processor individually or collectively, cause the primary AP to:
perform at least one of negotiating and distributing user density and traffic among the one or more identified neighbor APs based on a type of traffic and a service requirement.
